(19) United States
(12) Patent Application Publication
(10) Pub. No.: US 2003/0061500 A1
(43) Pub. Date: Mar. 27, 2003

(54) Signal processing method and device, and recording medium

(76) Inventors: Hideki Mimura, Yokohama-shi (JP); Kouya Tochikubo, Yokohama-shi (JP); Taku Kato, Kamakura-shi (JP); Tooru Kamibayashi, Chigasaki-shi (JP); Akio Tanaka, Yokohama-shi (JP); Hisashi Yamada, Yokohama-shi (JP); Tadashi Kojima, Yokohama-shi (JP)

Correspondence Address: PILLSBURY WINTHROP, LLP, P.O. BOX 10500, MCLEAN, VA, 22102, US

(21) Appl. No.: 10/238,887

(22) Filed: Sep. 11, 2002

(30) Foreign Application Priority Data
Sep. 27, 2001 (JP) 2001-298632

(51) Int. Cl. H04L 9/32

(52) U.S. Cl. 713/193

(57) ABSTRACT

In a signal processing system in which a data block containing encrypted main data and error correction codes is formed of symbols of M rows×N columns (M×N), one row is divided into R frames, a synchronous signal is added to each frame, data of each frame is modulated by a modulator, and the data is recorded on a recording medium or transmitted on a transmission path, an encrypted key encrypting the main data is modulated by a modulator other than the modulator of the data block signal. Copying of a recording medium, on which information for which copyright protection is required is recorded, can be easily prevented.

### CROSS-REFERENCE TO RELATED APPLICATIONS

This application is based upon and claims the benefit of priority from the prior Japanese Patent Application No. 2001-298632, filed Sep. 27, 2001, the entire contents of which are incorporated herein by reference.

### BACKGROUND OF THE INVENTION

1. Field of the Invention

The present invention relates to a signal processing method and device for recording a digital signal on a recording medium, for reproducing a digital signal recorded on a recording medium, for transmitting a digital signal, or for receiving a digital signal, and further, to an information recording medium on which a digital signal is recorded. The present invention also relates to a processing method for recording on an information recording medium and reproducing from an information recording medium, which are necessary for illegal copy prevention processing from the standpoint of copyright protection or the like.

2. Description of the Related Art

In recent years, as is called the digital revolution, various types of information are digitized, and techniques which can distribute information via media such as transmitting media, recording media, and the like have been developed. In accordance therewith, many people have come to be able to freely acquire digital information. In such an environment, digital audio signals, digital video signals, and other digital signals processed by a computer are recorded on recording media. Moreover, information transmission and information storage, such as the above-described signal being reproduced from a recording medium, information being recorded on a reproduction dedicated information medium, recorded information being reproduced, information being transmitted at a transmission line, and the like, are carried out.

Currently, as a recording medium which can record a large quantity of information of image/sound signals, DVDs (Versatile Digital Discs) has been realized. A motion picture of two hours or more can be recorded on the DVD. Since the information recorded on the DVD can be reproduced by a reproduction device, the motion picture can be freely watched in a home.

As DVDs, there are a DVD-ROM dedicated for reproduction, DVD-R which can record once, DVD-RW, and DVD-RAM which can freely record and reproduce, and the like.

As application standards for the DVD-ROM, there is a DVD-video standard, and a complete motion picture is recorded on one disc. By reproducing such a DVD-video disc or receiving a digital broadcast by a broadcast system, users can freely acquire information by a digital signal. In such an environment, if the acquired digital signal is copied on a recording medium such as a hard disc, the above-described DVD-RAM, or the like, and is again encoded by an encoder conforming to the DVD-video standard and recorded, another disc, on which a digital signal which is the same as that of the original disc is copied, can be prepared.

Thus, in the DVD-video standard, encryption is carried out on the recorded digital information. A copy protection method using an encrypting technique effectively functions on a DVD-video disc or a DVD-ROM disc on which information encoded in advance is recorded.

In fields in which such information transmission/storage processing is carried out, in recent years, copyright protection has become important. In particular, when information requiring copyright protection is recorded on an ordinary recording medium, there is need to prevent illegal copying from being carried out. Namely, it can be supposed that illegal actions, in which the same information is recorded on a plurality of recording media regardless of the copyright holder permitting information recording on only one recording medium, will arise, and prevention of such improprieties is indispensable.

### BRIEF SUMMARY OF THE INVENTION

An object of the present invention is to provide a signal processing method and apparatus which prevents copying of a recording medium on which information for which copyright protection is required is recorded even in a system comprising a recording drive used in a computer environment and a PC in which editing of information is easy, and which has a copyright protection system which easily individually manages a plurality of contents, and to provide a signal recording medium on which such information is recorded.

According to an embodiment of the present invention, a signal processing method comprises:

forming a data block including encrypted main data and an error correction code, the data block being formed of symbols of M rows×N columns, one row being divided into R frames (M, N, R being integers), and a synchronous signal being added to each frame of the data block;

modulating the encrypted main data by a first modulator;

modulating an encryption key of the main data by a second modulator; and

combining the modulated main data and the modulated encryption key to obtain an output to be recorded on a recording medium or transmitted on a transmission path.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a block diagram showing a recording data processing process according to a DVD system;

FIG. 2 is an explanatory diagram showing a structure of a data sector according to the DVD system;

FIG. 3 is an explanatory diagram showing a structure of an ECC (Error Correction Code) block according to the DVD system;

FIG. 4 is an explanatory diagram showing a structure of a recording sector according to the DVD system;

FIG. 5 is an explanatory diagram showing a structure of an ECC block after row-interleaving processing according to the DVD system;

FIG. 6 is an explanatory diagram showing a structure of a physical sector according to the DVD system;

FIG. 7 is an explanatory diagram of a copyright protection system in the DVD system;

FIG. 8 is a schematic explanatory diagram of a DVD player;

FIG. 9 is an explanatory diagram of a DVD-ROM drive and an MPEG decoder module mounted in a personal computer (PC) system;

FIG. 10 is an explanatory diagram of a content encryption method of CSS (Content Scramble System);

FIG. 11 is an explanatory diagram of content decoding processing in the DVD player;

FIG. 12 is an explanatory diagram of bus authentication and content decoding processing in the PC system;

FIG. 13 is an explanatory diagram of a copyright protection system in a recording/reproduction device;

FIG. 14 is an explanatory diagram showing a schematic structure of the recording/reproduction device;

FIG. 15 is an explanatory diagram showing an example of a data flow when an illegal copying is carried out;

FIG. 16 is a diagram showing a portion of a conversion table for modulator used at the DVD system;

FIG. 17 is a diagram showing a structural example of a signal processing device according to an embodiment of the present invention;

FIG. 18 is an explanatory diagram showing an example of a modulated data block in which a modulated encrypted key is inserted;

FIGS. 19A, 19B, and 19C show an example in which modulated encrypted keys are embedded by the modulated signals of main data;

FIG. 20 is a diagram showing another example in which modulated encrypted keys are embedded in the modulated signals of main data;

FIG. 21 is a diagram showing yet another example in which modulated encrypted keys are embedded in the modulated signals of main data;

FIGS. 22A, 22B, 22C, 22D, 22E, 22F, and 22G show still yet another example in which modulated encrypted keys are embedded in the modulated signals of main data; and

FIG. 23 is a diagram showing another structural example of the signal processing device according to another embodiment of the present invention.

### DETAILED DESCRIPTION OF THE INVENTION

An embodiment of a signal processing method and device, and a recording medium according to the present invention will now be described with reference to the accompanying drawings.

[I] Details Studied in Order to Realize the Invention

Hereinafter, a copyright protection system used in an optical disc DVD which recently has been markedly becoming popular will be described.

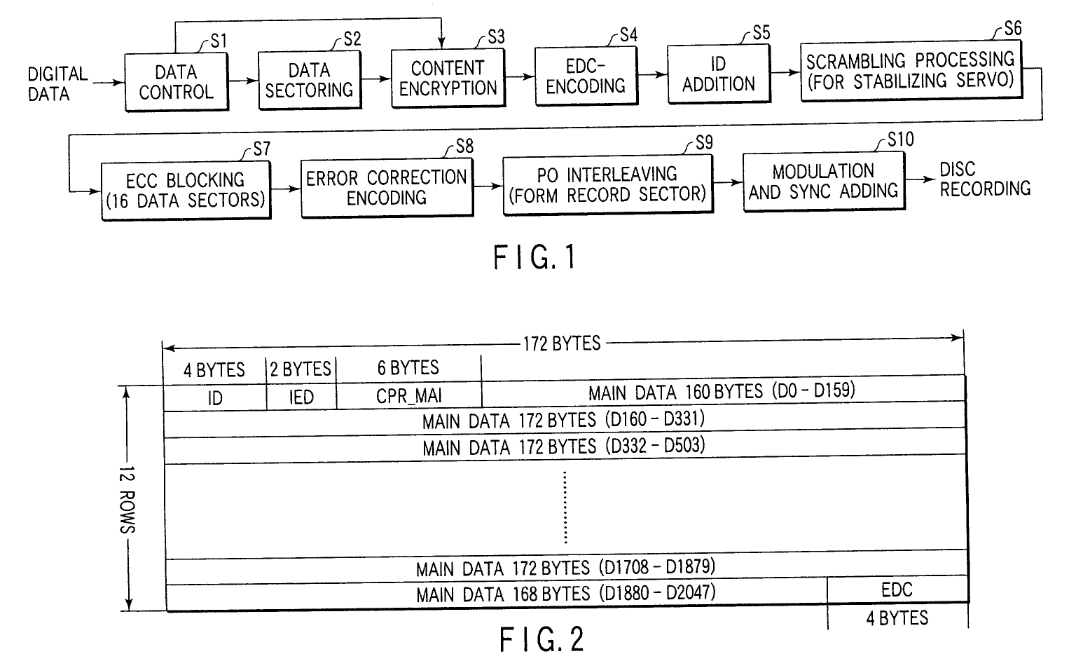

FIG. 1 shows a signal processing process onto a recording medium in a copyright protection system of a DVD-video signal. A video/audio information signal which is digital data is compression-processed by an MPEG method or the like, and is formatted in a digital stream to which a reproduction control signal or the like is further added (data control step S1).

Digital data is sectored into packet data of 2-Kbytes units (step S2), and the data is encrypted (data-scrambled) (step S3). An error-detection code EDC is added to the encrypted data (EDC encoding step S4), and an ID which is a sector number is added to each sector (step S5). Thereafter, for the purpose of stabilizing the servo system in a reproduction operation or the like, a data portion is scrambled by a code to be determined by ID information (step S6).

Data scrambling differs from the above-described scrambling for encryption, and scrambles the data by open contents. The purpose thereof is for the recording data to repeat the same pattern, in a case such as when the digital data is “all 0”. In this case, because there is the fear that trouble will arise, such as a tracking servo error signal cannot be precisely detected or the like due to crosstalk of an adjacent track or the like in a disc system. The initial value of an M-sequence generator is determined by the ID value. By multiplying the signal from the M-sequence generator by the digital data, data scrambling is carried out. Thus, the data-scrambled recording signal is prevented from repeating the same pattern. In the present specification, “data scrambling” used for servo stabilization is only this explanation, and “data scrambling” described in other items shows data scrambling used for encryption processing used for copyright protection of information.

The digital data to which the above-described processings have been applied is made into error correction code (ECC) blocks in units of 16 sectors for error correction processing (step S7). Error correction codes of an inner-code parity PI and outer-code parity PO are generated (step S8).

PO is dispersed and provided at each sector by interleaving processing, and a recording sector is structured (step S9). The recording sector data is modulated by a modulating circuit (modulation and sync adding step S10), and the modulated signal is recorded on an original master disc.

The original master disc is used in the disc manufacturing processing process to prepare a metal mold for disc manufacturing. By using an injection machine or the like, a large quantity of discs are copied, and are provided on the market as DVD-ROM discs on which video signals are recorded.

FIG. 2 shows the structure of the data sector in FIG. 1.

The data sector is formed of (1 row=172 bytes)×12 rows. A sector identification information ID of 4 bytes formed of the sector number and sector information is arranged at the head line, and there follows an ID error-detection code IED of 2 bytes, a copyright protection related information CPR_MAI of 6 bytes, and thereafter, there is a main data region of 2K bytes, and lastly, an error-detection code EDC of 4 bytes for the main data is added.

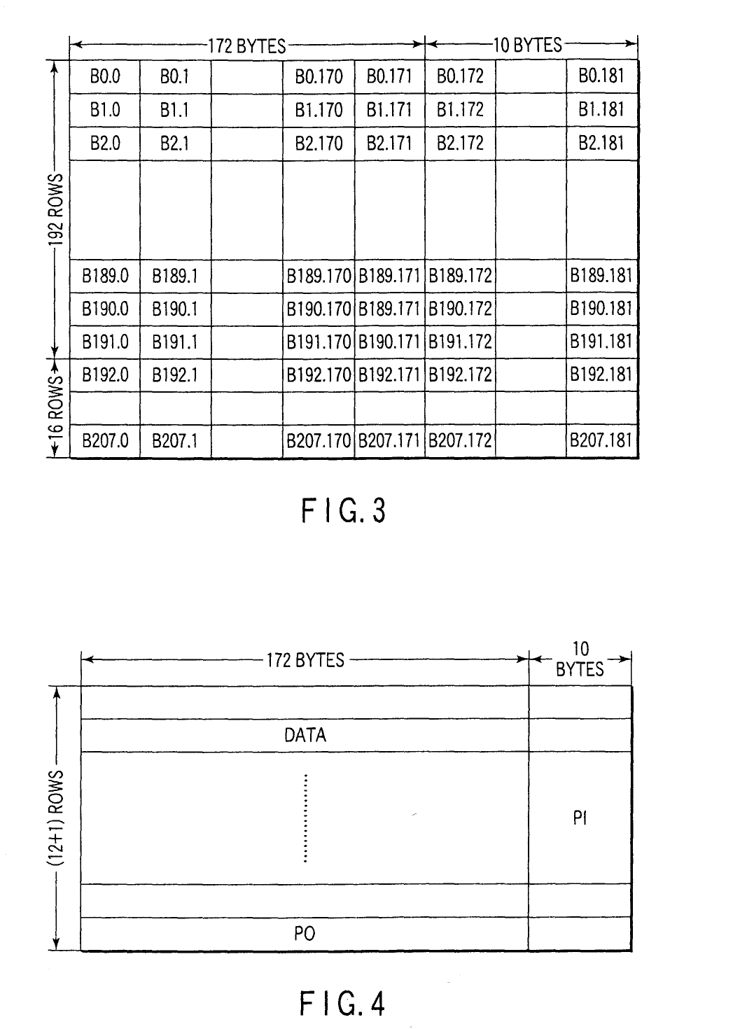

FIG. 3 shows the structure of an ECC block. In the data of 172 bytes×192 rows formed of 16 sets of the data sector of FIG. 1, the outer-code parity PO of 16 bytes (16 rows) is generated for each column (vertical direction), and the inner-code parity PI of 10 bytes (10 columns) is generated for each row (transverse direction). Here, the outer-code parity PO of 16 rows (16 bytes) is dispersed and provided 1 row (byte) by 1 row (byte) every 12 rows (each sector).

FIG. 4 shows the structure of one sector after dispersing the outer-code parity PO. This is called a recording sector. Because the outer-code parity PO of 1 row is added to the sector (12 rows) shown in FIG. 2, the sector comprises (12+1) rows.

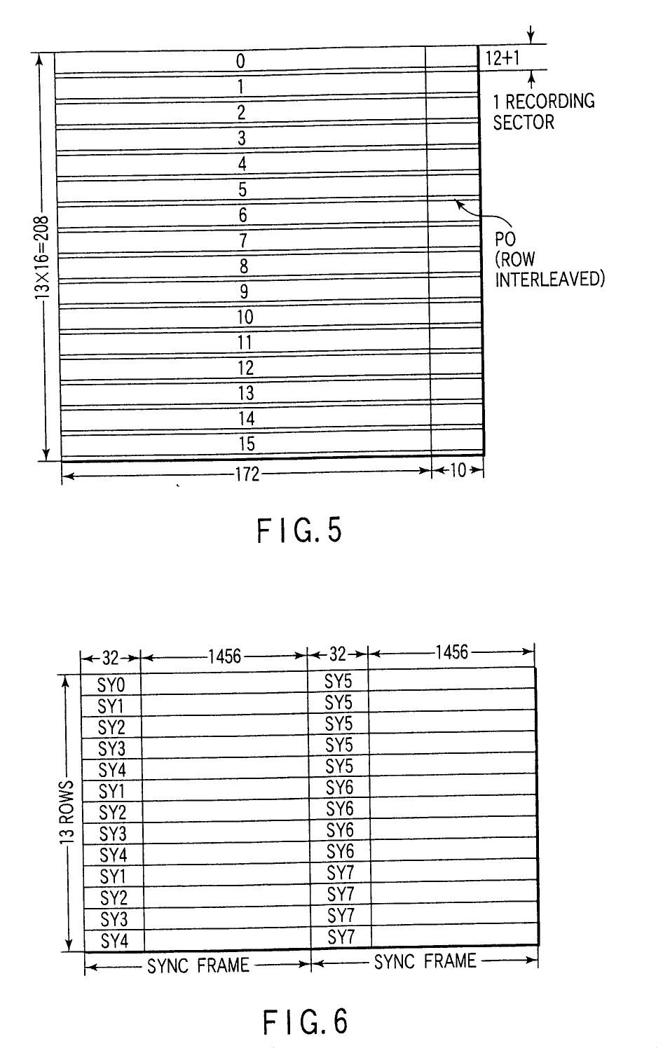

FIG. 5 shows the structure of the ECC block comprising 16 recording sectors. Namely, there is a state in which 16 recording sectors are gathered.

Data streams of the respective recording sectors are made to pass through a modulator, and a physical sector is formed. FIG. 6 shows the structure of the physical sector.

The modulator code-converts the respective data symbols (1 byte=8 bits) into 16 channel bits. One portion of a code conversion table for modulator used for the DVD standard is shown in FIG. 16. Here, together with the processing in which the data symbol is code-converted, synchronous signals (sync) of 32 channel bits are added to the head and the intermediate position of the respective rows of the recording sector. The synchronous signals are arranged such that there is a synchronous signal of a different pattern at each row, and it is contrived such that the row position of the each sector can be known in accordance with the combination of the synchronous patterns at the time of reproduction processing.

As shown in FIG. 6, one row is formed of two groups of sync frame of (32+1456) channel bits. For example, in the first row of FIG. 6, SY0 and SY5 are sync frames. A physical sector is structured by gathering 13 of such rows.

In such a DVD, as the copyright protection system, it is attempted to protect information such as the video signal recorded on a reproduction dedicated ROM disc or the like. In this case, as the copyright protection system, a copyright protection system called CSS (Content Scramble System) is utilized.

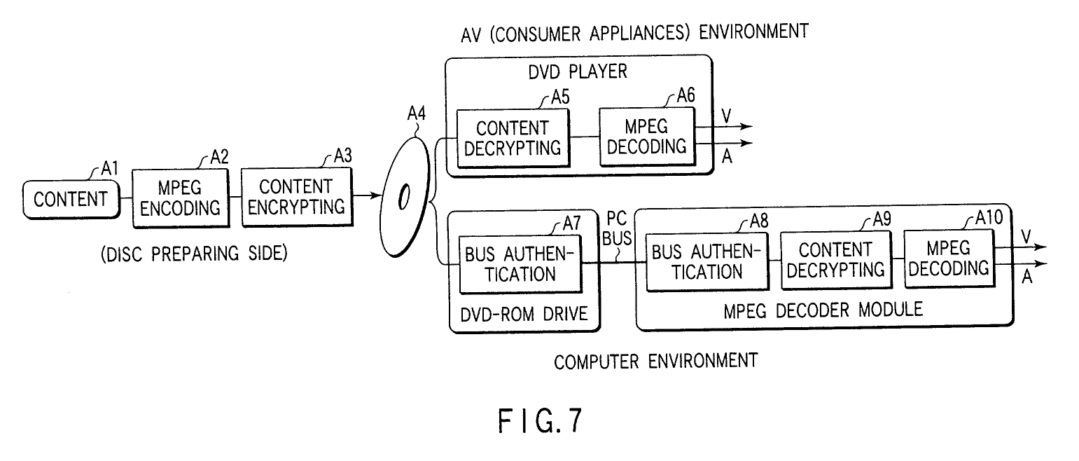

FIG. 7 is a schematic diagram of the copyright protection system CSS (Content Scramble System) of a DVD-video signal used for reproduction dedicated media of the DVD standard.

At the side of disc recording, the digital content is MPEG-encoded, and encrypted by the CSS system, and recorded on a read-only medium (steps A1, A2, A3 and A4). Reproduction processing for this medium, at a general DVD dedicated player (a consumer appliance), the encrypted contents are decrypted (step A5), and the compressed data is expanded by an MPEG decoder or the like (step A6), and it is reproduced as a video/audio signal.

In a reproduction processing in a computer environment of a personal computer or the like, the digital data from the above-described medium is reproduced by a DVD-ROM drive (step A7). The read digital data is not transmitted as is on a PC bus, and firstly, MPEG decoder module and authentication mutual identification (bus authentication) are carried out (steps A7 and A8). Further, this is a system in which the encrypted contents are transferred to only a proper decoder module. In this case, the data is transferred from the DVD-ROM drive to the decoding section, and the encrypted contents are decrypted (step A9). The compressed data is expanded by the MPEG decoder or the like (step A10), and it is reproduced as the video/audio signal.

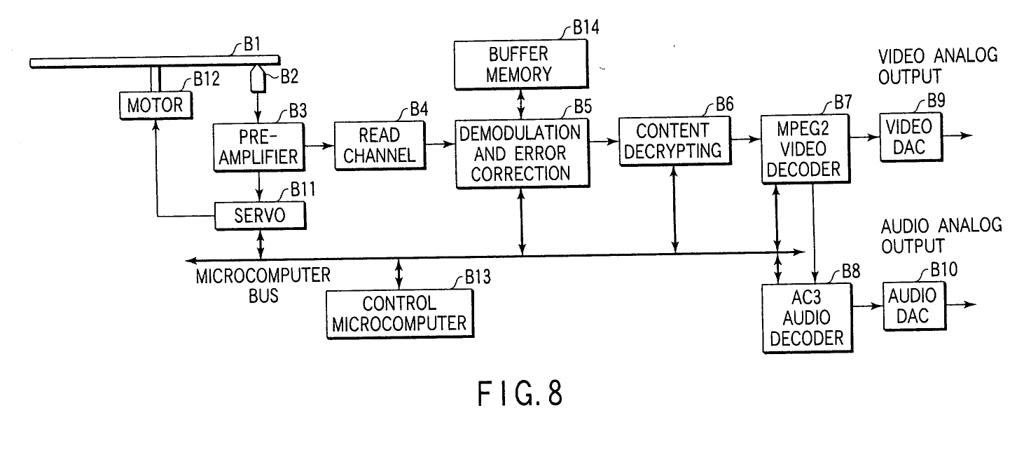

In FIG. 8, the schematic structure of a DVD player (a consumer appliance) is shown. In the DVD player, the signal is read via an optical pickup B2 from a medium B1. The read signal is amplified by a pre-amplifier B3, and is binarized by a read channel section B4. The binarized signal is demodulated as digital data by a demodulation/error correction section B5. The digital data is decrypted from the encrypted state by a content decryption block B6. The decrypted, compressed video/audio signal is restored to the original base band image/voice data by compression→expansion decoder blocks (an MPEG-2 video decoder B7 and an AC3 audio decoder B8), and is converted to an analog signal by digital-analog converting sections (DAC) B9 and B10, and output.

A servo circuit B11 and a motor B12 are for rotating-controlling the medium as a disc. Further, B13 is a control microcomputer for controlling the other blocks. A buffer memory B14 is connected to the content decryption block B6.

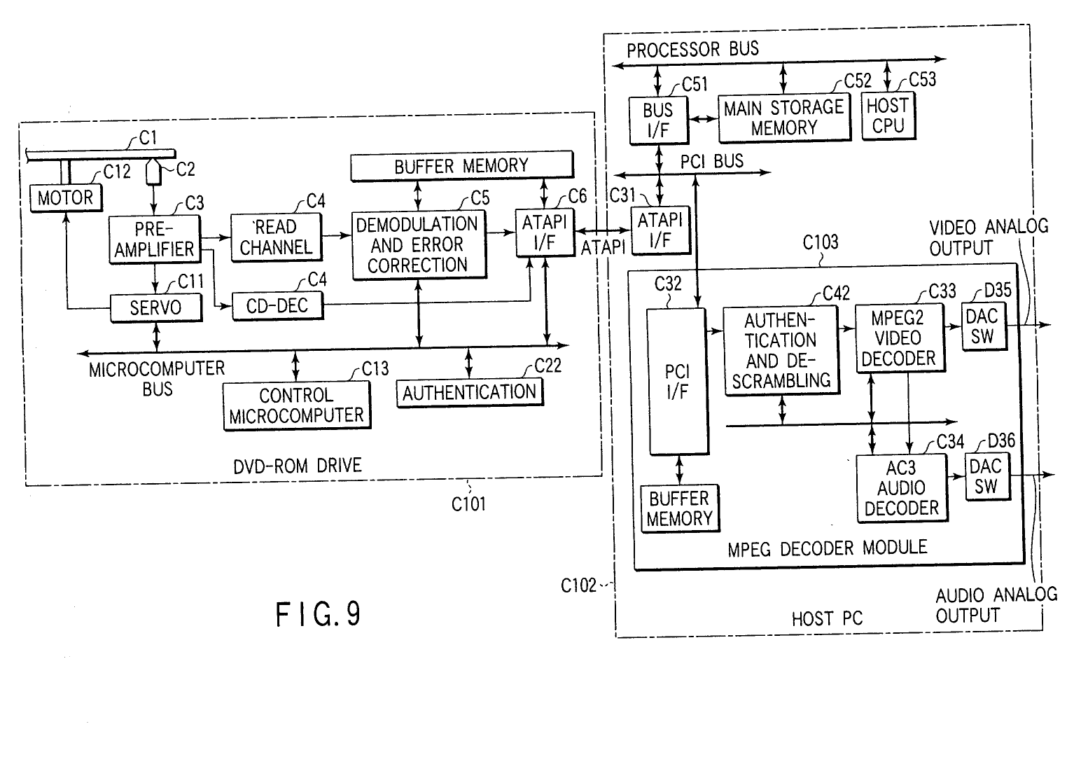

FIG. 9 shows a structure of a DVD-ROM drive C101 and an MPEG decoder module C103 in a personal computer (PC) system (computer environment).

C1 is a medium as a disc, C2 is an optical pickup, C3 is a pre-amplifier, C4 is a read channel section, and C5 is a demodulation/error correction section. Further, C6 is an interface unit, C11 is a servo circuit, C12 is a motor, and C13 is a control microcomputer. Note that C21 is a CD decoder for reproducing ordinary compact discs.

The DVD-ROM drive C101 reads a signal from the medium C1 via the optical pickup C2 in the same way as in a general DVD player. The read signal is demodulated/error correction-processed by the blocks C3, C4, and C5, and transmitted from the interface unit (ATAPI-I/F) C6 to a host PC C102. However, before the information is transmitted, authentication is carried out at the drive C106 and an MPEG decoder module C103 such that the information output from the interface C6 is transferred to only the MPEG decoder module C103 at the PC side.

Authentication processing is for not recording the information on other recording media even if there are other recording media at the side of the host PC C102. The authentication processing is carried out between an authentication processing section C22 and an authentication and descrambling section C42.

In the MPEG decoder module C103 at the side of the host PC C102, a PCI interface C32, decoders (an MPEG-2 video decoder C33 and an AC3 audio decoder C34), and the like are provided. The digital data from the respective decoders are analog-converted by digital-analog converting sections D35 and D36. Further, the host PC C102 also has a bus interface C51, a main storage memory C52, a host CPU C53, and the like.

In FIG. 9, the data is transferred to the PCI bus of the host PC C102 from the ATAPI-I/F C6 at the side of the DVD-ROM drive C101, through the ATAPI-I/F C31 at the side of the host. Here, authentication processing is carried out by the host PC C102, and it is corresponded by a system such that the information data is transferred to only an authenticated module.

The CSS, which is a system in which only the authenticated module can receive the accurate information data, will be described by using FIG. 10 to FIG. 12.

FIG. 10 is a schematic diagram of a content encryption method of the CSS.

Three encryption key data, namely, a master key which the CSS management mechanism holds, and a disc key and a title key which a copyright holder or the like determine, are hierarchically combined, and data of video and audio are encrypted by the encryption key.

In the example of FIG. 10, the disc key is encrypted by using the master key (block D1), and it becomes a disc key set. The title key is encrypted by using the disc key by the encrypting section (block D2), and it becomes an encrypted title key. A content such as image data, audio data, and the like from a content section (D3) is compression-processed by a compression processing section (block D4), and the compressed data is scrambled by a scrambling section (block D5).

The master key is an encryption key data differing for each manufacturer of a decryption LSI or a software CSS module.

The CSS management mechanism collectively holds the master keys of a large number of manufacturers. When the disc key is encrypted, a disc key set which can basically be decrypted by any of the master keys is prepared, and the disc key set is stored on a disc. Thus, damage when information of a master key given to a manufacturer leaks can be kept to a minimum.

Concretely, from the next time of preparing a disc key set, a disc key set prepared with the leaked master key removed is prepared. Thereafter, decrypting by using the leaked master key cannot be carried out.

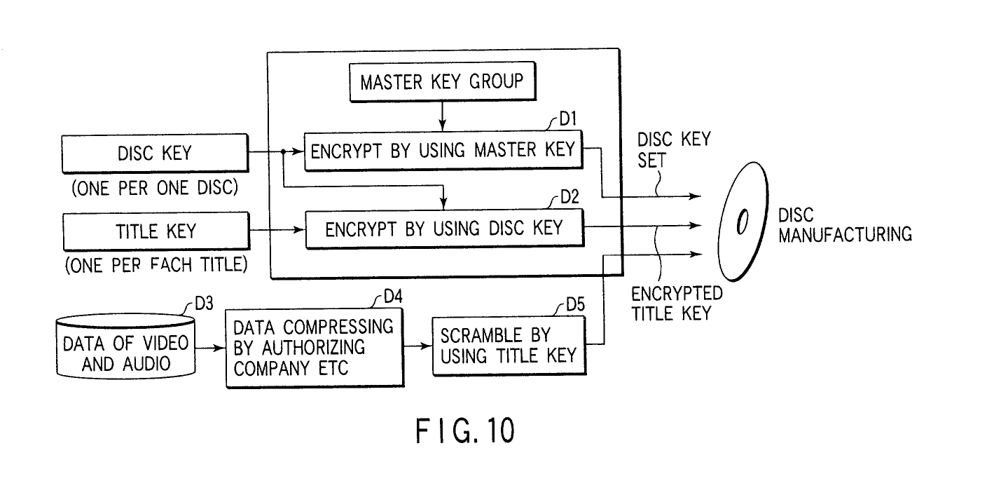

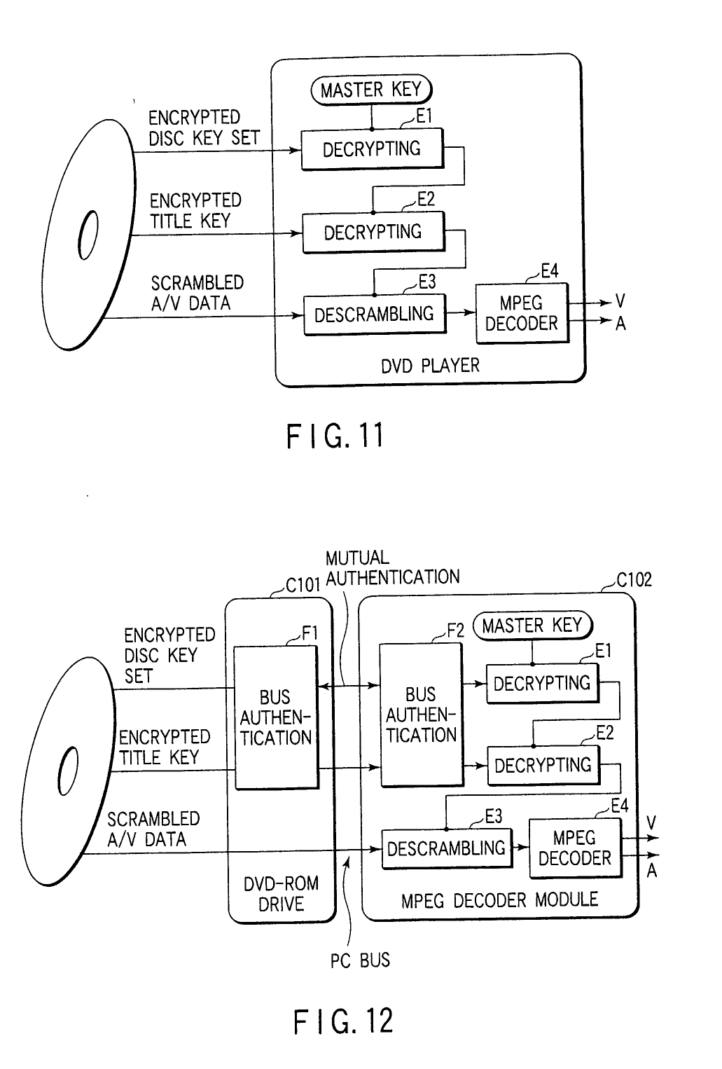

FIG. 11 is a schematic diagram of content decryption in the DVD player reproducing a disc on which the encrypted content prepared in FIG. 10 is recorded. The encrypted “disc key set” is read from the disc, and the disc key is decrypted by using the master key by a decrypting section (block E1). The encrypted title key read from the disc in the same way is decrypted by the above-described decrypted disc key by a decrypting section E2. Further, scrambled “A/V data” which is the content is descrambling-processed by using the decrypted title key by a descrambling section E3. The descrambled content is reproduced as the video/audio signal by an A/V decoder (block E4) such as an MPEG-2 decoder or the like.

FIG. 12 is a schematic diagram of bus authentication and content decryption in a PC system.

In a PC system, due to the encrypted key and the encrypted content being recorded as they are in another recording medium, it is possible to copy, and copyright protection does not make sense. As described in FIG. 9, mutual authentication is carried out with the MPEG decoder module C103 in the host PC, and when the encrypted “disc key set” and the encrypted “title key” are transmitted to the MPEG decoder module C103 from the DVD-ROM drive C101, a session key having a time limiting function is generated, and the encrypted “disc key set” and the encrypted “title key” are re-encrypted and transmitted. Thus, there is realized a system in which the key information sent to elsewhere than the authenticated MPEG decoder module cannot be decrypted, and which carries out copy prevention of information encrypted as it is.

The sections carrying out the above-described processing are, as shown in FIG. 12, bus authentication sections (blocks F1, F2) provided at a PC bus C111 between the DVD-ROM drive C101 and the MPEG decoder module C102.

In the MPEG decoder module C102, the point different from the DVD player of FIG. 11 is the point that bus authentication functions (blocks F1 and F2) are provided. Here, the drive C101 is authenticated and the encrypted “disc key set” and encrypted “title key”, which are re-encrypted by the authentication key, are decrypted as the encrypted “disc key set” and the encrypted “title key” by the authentication key. Hereinafter, by using the master key in the same way as in the DVD player shown in FIG. 11, the title key for decrypting the content is decrypted (blocks E1 and E2), and descrambling processings of the content (blocks E3 and E4) are carried out.

The above descriptions are the contents of medium manufacturing processing by the reproduction dedicated CSS method and the reproduction system of the read-only medium on which the encrypted content is recorded. In this way, in order to carry out copyright protection, the content is encrypted by scrambling processing. In order to decrypt the encrypted content in the reproduction system, if the encrypted key is not decrypted, content decryption cannot be carried out. The copyright protection system in a reproduction device is realized as described above.

As the copyright protection system in a recording/reproduction device, it can be considered that a recording(encrypting)/reproduction(decrypting) system is configured by extending the above-described reproduction dedicated system.

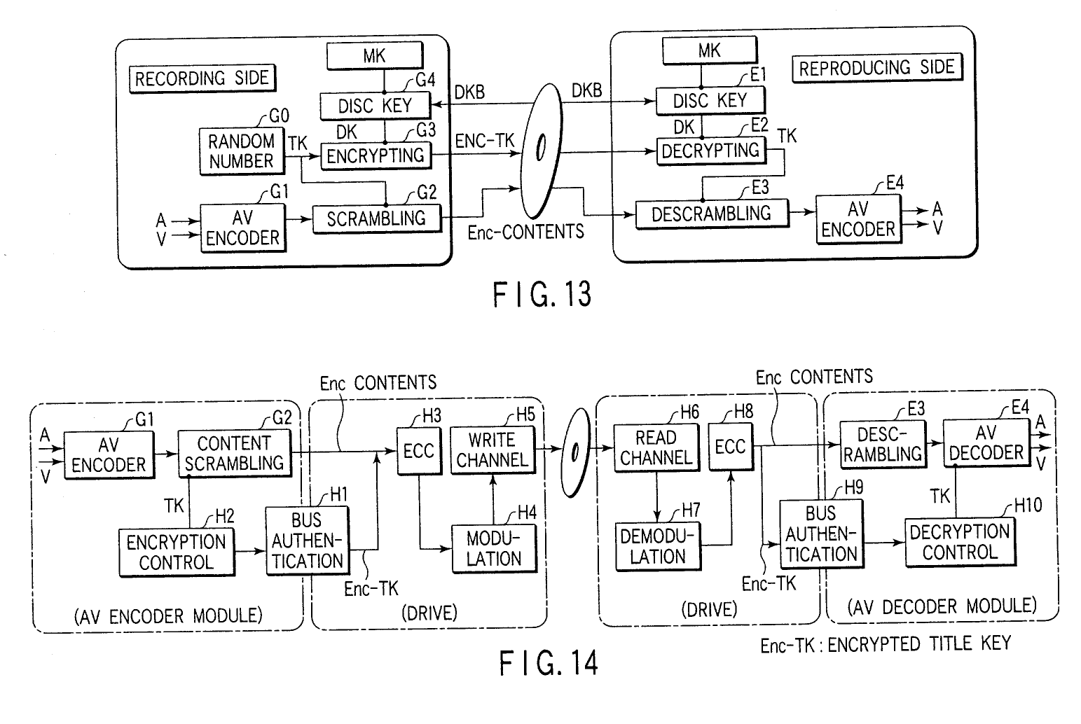

FIG. 13 shows the structure of the copyright protection system in a recording/reproduction device.

A block G0 is a random number generating device, a block G1 is an A/V encoding section, a block G2 is a scrambling section, a block G3 is an encrypting section, and a block G4 is a disc key processing section.

The audio(A)/video(V) content is encrypted by scrambling processing by using a title key TK generated in the random number generating device as a key (blocks G0, G1 and G2). On the other hand, the title key TK is encrypted by a disc key DK, and is recorded as an encrypted title key Enc-TK on a disc (block G3). The disc key DK is data obtained by reading a disc key set (or a disc key block) DKB from the medium and decrypting the disc key block DKB by the master key MK in the same way as the disc key in the reproduction dedicated device (block G4).

A bundle of disc keys, in which the disc key is encrypted by a number of the master keys MKs, is recorded on the medium in advance. The disc key DK is decrypted and extracted therefrom by the master key MK embedded by the recording/reproduction device, and is utilized as the encrypted key of the master key MK.

The reproducing side carries out decrypting of the content by a similar processing as in the processing described in FIGS. 11 and 12.

Accordingly, the same reference numerals are used for the portions corresponding to the processings shown in FIG. 11 and FIG. 12. By using such a structure, a copyright protection system can be formed in the recording/reproduction device.

FIG. 14 is a block diagram of the schematic structure of the recording/reproduction device. In a dedicated recorder in a general consumer environment, illegal copying is rarely supposed. However, in a PC (personal computer) environment, it is easily possible to copy data read by a drive onto another recording medium.

In a PC environment, a recording medium is regarded as a peripheral device. At the input/output of the drive in FIG. 14, recording/reproduction operation is generally carried out with no concern to the contents of the data. Therefore, in order to deal with copyright protection, it is necessary to use the bus authentication system shown in FIG. 12 which is a reproduction dedicated system.

At the recording side, the title key TK which is an encryption key is encrypted by a disc key DK and made to be the encrypted title key Enc-TK. When the encrypted title key Enc-TK is to be transferred to a drive, it is necessary to transfer it through a bus authentication processing H1. In other processings, processings which are substantially the same as the respective processings in the CSS are carried out.

In FIG. 14, the A/V encoder G1 and the content scrambling section G2 are provided in an A/V encoder module at the recording side. An encode control section H2 corresponds to the random number generating device G0, encrypting section G3, and disc key processing section G4 of FIG. 13.

At the drive, ECC encoding by an ECC encoding section H3, modulating processing by a modulator H4, and writing processing onto a medium by a writing processing section H5 are executed.

At the reproducing side, at the drive, signal reading from the medium by a signal reading section H6, demodulation processing by a demodulator H7, and decoding by an ECC decoding section H8 are carried out. Further, at the time of reproduction as well, mutual authentication by a bus authentication section H9 is executed between the drive and the A/V decoder module. After confirming the mutual authentication, the output of the ECC decoder H8 is descrambled by the descrambling section E3, and decoded by the A/V decoder E4. A decode control section H10 corresponds to the disc key processing section E1, decrypting section E2, and descrambling section E3 in FIGS. 11 to 13.

The copy protection method using the encryption technique described above effectively functions in a DVD-video disc or a DVD-ROM disc on which previously encrypted information is recorded. However, in the case of a DVD-RAM or the like on which users can newly record information, the following problems arise.

(1) In a recording device that general users utilize, it is difficult to introduce a strong and low-priced encrypting device.

(2) It is difficult to manage an encryption key at the time of encryption. When encrypting and decrypting are carried out at the information recording device side, there is a high possibility that copying of information, for which copy protection is desired, can be easily carried out.

(3) If the encrypted content and encrypted key are copied as a whole, an illegal disc which can be reproduced by a regular device is made (when there is no concealed region).

(4) When an audio signal is processed, it must be processed in units of a large number of files (compositions). Therefore, it is difficult to maintain a copyright protection function for a request to manage in file units.

(5) As described above, it is difficult for a conventional encrypting technique to, as it is, effectively function in the copy protection of digital information signals. When encrypted recording information is reproduced, decrypting processing is carried out in the reproduction processing, and depending on the processing of the decrypted digital signal, the possibility of illegal copying still remains. In particular, by copying the encrypted information and the encrypted key as a whole, there is the possibility that a large quantity of copied recording media can be prepared.

As in the case of the DVDs, if various types of media such as read-only DVD-ROMs, and recordable DVD-Rs, DVD-RWs, and DVD-RAMs or the like are present, it is difficult to distinguish whether the digital signal recorded on the recording medium is an original signal or an illegally copied digital signal.

With respect to this problem, a similar problem arises in other recording media. Therefore, from the standpoint of copyright protection, it is desirable that information signals are encrypted such that only correct systems can decrypt, and it is determined whether the input digital signal is an original digital signal or an illegally copied signal at the entrance of the reproducing side. If a portion of the protection system is built in a region which general users cannot process, the ability of copyright protection can be largely improved.

[II] Problems of Interest

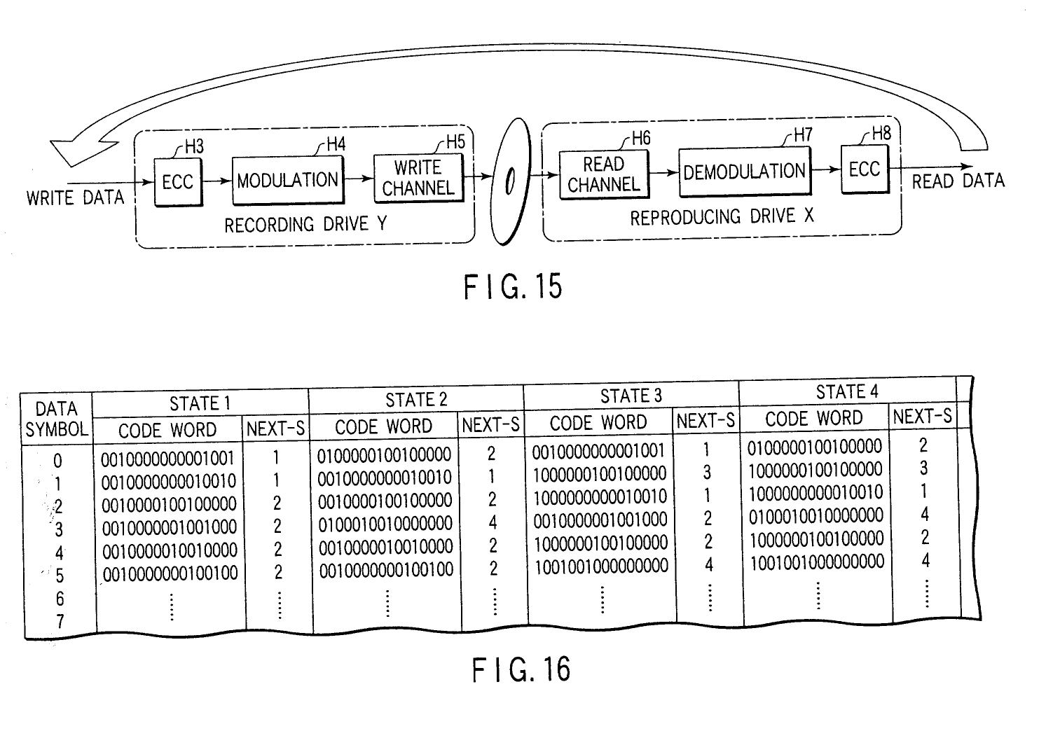

FIG. 15 illustrates a state in which entire copying is carried out, namely, a route of illegal copying. Generally, at a recording drive to be used in a computer environment, the object is to record/reproduce information by an instruction from a PC. Therefore, the contents (the contents of the information, the control code for the information, and the like) recorded on a medium are not determined. Thus, the read data is open.

In FIG. 15, if all of the data read by a drive X are recorded in the order of reading by a drive Y, a plurality of the same, recorded recording media can be prepared.

In consideration of such circumstances, a “Copyright Protection System Using Electronic Water-Mark” has been proposed in Japanese Patent KOKAI Publication No. 11-86436. Namely, specific information is inserted and recorded at a specific position of information to which an error correction code is added, and an error pattern is extracted by error correction processing at the time of reproduction, and the specific information is detected from the error pattern. In this method, the specific information is not contained in the data transmitted from the drive by error correction processing, and the specific information is contained in the error pattern. Therefore, the specific information is deleted by the correcting processing being carried out.

As a result, if only the data after error correction processing is transferred to the exterior, the specific information can be detected only in the drive, and the copyright protection function can be improved by utilizing the specific information. Namely, the specific information can be used as a controlling signal of copyright protection indicating, for example, whether the recorded signal is an original signal or an illegally copied signal. In this method, the specific information is not included in the reproduced digital signal because the specific information is inserted as an error pattern. Further, because the correcting processing is a process which general users, who use system devices, do not access, it is suitable for detecting illegalities. The specific information detected by this method can be called a disappearing electronic watermark. The specific information disappears from the original digital signal due to correcting processing being applied, and it can be considered to be effectively utilized in determining whether it is an original signal or an illegally copied signal by the presence/absence of the signal.

However, in this method as well, there is a drive controlling command which directly transfers to the exterior the data read at the drive, without carrying out error correction. In a drive corresponding to such a command request, the data, in which an error pattern is contained as it is, is transferred to the exterior, and as a result, the specific information can be detected at the exterior.

[III] Specific Countermeasures

The CSS used at a DVD as a protection system for content is described with reference to FIG. 10 to FIG. 12. Because the system is reproduction-dedicated, and because the management of an encryption key is carried out by the CSS management mechanism, protection is easy. However, in a recording/reproduction system, the management of keys is complicated, and it is difficult to provide a low-priced protection system. In particular, in the block diagram shown in FIG. 15, if a method in which all of the data of a recording medium is entirely copied is adopted, an illegally copied recording medium can be made. Further, in a PC environment, it can be supposed that an illegal user performs a manipulation and edition of data transmitted from the drive and a special signal detection. Thus, it is necessary to provide some type of prevention system before the data is output from the drive X. In the present embodiment, by modifying modulators/demodulators H4 and H7 in FIG. 15 and providing a method in which the specific information for encryption is recorded and reproduced, a system which can carry out low-cost copyright protection is structured. The drives X and Y are basically formed of the ECC processing sections H3 and H8, the modulating sections H4 and H7, and the writing processing/reading processing sections H5 and H6.

FIG. 16 is a portion of a code conversion table of a modulating method used for the DVD standard.

In the DVD standard, because data symbol is handled in the unit of 1 byte (8 bits), code words of 16 channel bits are allocated to 256 data symbols from “0” to “255”. A code word of 16 channel bits is structured such that the distance from “1” to the next “1” is in a region of 3 to 11 bits. Further, when the code word and the cord word are connected as well, the distance from “1” to the next “1” is structured so as to be 3 to 11 bits. Therefore, four tables from State-1 to State-4 are prepared at each data symbol. Further, a state (next state or table), in which a code word to be used exists, is determined in advance for each code word used at the time of modulating (converting) the data symbol.

In this modulating method, the channel bit data formed as a result of being selected from the code words of the conversion table carries out polarity inversion of the recording signal at “1” of the code word by an NRZI (Non Return to Zero Inverted) method. By the inversion processing, the continuous “1”s of the recording signal are within a range of 3 to 11, and the continuous “0”s of the recording signal are within a range of 3 to 11.

However, 14 continuous patterns are inserted into the synchronous signal SYNC in FIG. 6, and synchronous signal detecting is carried out by utilizing a pattern which is not in a general data recording.

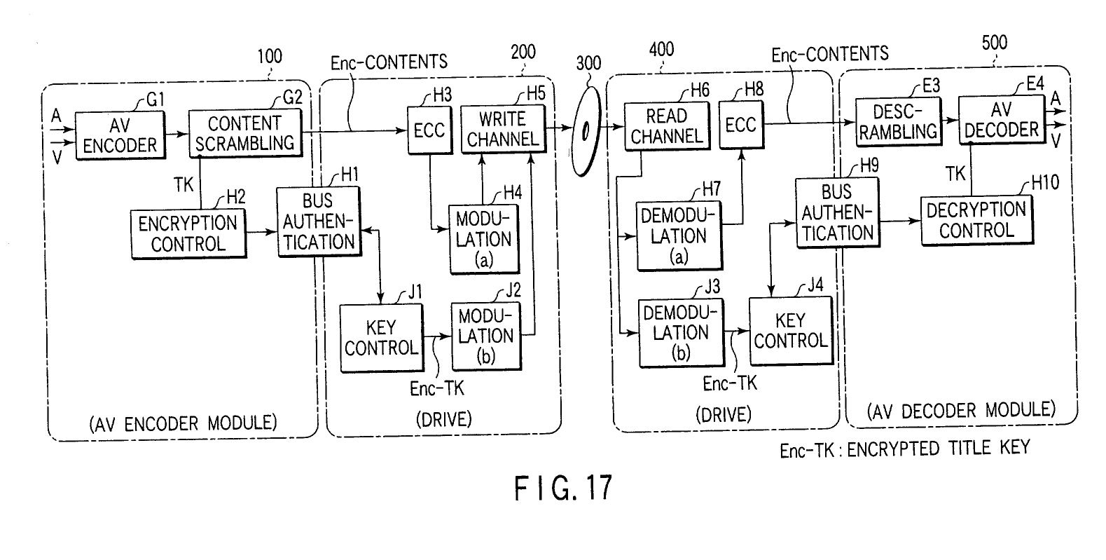

FIG. 17 is a structural example of a recording/reproduction system in which a copyright protection system using the present embodiment is built in.

The present system comprises an A/V encoder module 100, drive 200, information recording medium 300, drive (in actuality, integrated with the drive 200) 400, and A/V decoder module 500. The drives 200/400, and respective modules 100 and 500 are made to be ICs.

An A/V encoder G1, content scrambling section G2, and encryption controlling section H2 are provided in the A/V encoder module 100. An ECC encoding section H3 which gives an error correction code for the signal from the content scrambling section G2, modulator H4 modulating the ECC encoding output (ECC block), and writing section H5 are provided in the drive 200.

A bus authentication section H1 is provided between the A/V encoder module 100 and the drive 200. The bus authentication section H1 connects the encryption controlling section H2 and a Key controlling section J1, and carries out bus authentication between the A/V encoder module 100 and the drive 200. The title key TK which is the encryption key (specific information) is encrypted by a disc key DK and made to be encrypted title key Enc-TK. This is because, when the encrypted title key Enc-TK is transferred to the drive 200, it is necessary to transfer the encrypted title key Enc-TK via the bus authentication processing section H1.

In the present embodiment, the encrypted title key Enc-TK is modulated by a modulator(b) J2 and transferred.

At the reproducing side, the drive 400 reads the recording information from the information recording medium 300. Namely, in the drive 400, signal reading by a signal reading section H6, demodulation/processing by a demodulator H7, and decoding by an ECC decoding section H8 are carried out.

The output of the signal reading section H6 is supplied to a demodulator(b) J3. In the demodulator(b) J3, the encrypted title key Enc-TK is demodulated. After this demodulation is carried out, mutual authentication is carried out via a bus authentication section H9 between a key controlling section J4 and decryption controlling section H10 of the A/V decoder module 500.

After the mutual authentication has been confirmed, the output of the ECC decoder H8 is descrambled by a descrambling section E3, and decoded by an A/V decoder E4. The decryption controlling section H10 corresponds to the disc key processing section El, decrypting section E2, and descrambling section E3 shown in FIG. 13.

The system of FIG. 17 is different from the recording/reproduction system of FIG. 14. In addition to the modulator(a)/demodulator(a) H4 and H7 for main data, the modulator(b)/demodulator(b) J2 and J3 exclusively used for recording and reproducing of the encrypted key are provided.

As a result, at the modulation/demodulation processing relating to the main data, signals of a portion of the encrypting processing are errors, and a portion of the encrypting processing functions is not output from the drive. The processing process of FIG. 17 will be simply described.

At the recording side, an encoding processing such as compression by the A/V encoder G1, controlling code adding, and the like are carried out on the audio(A)/video(V) signal. The main data is scramble-processed by the title key TK in the content scrambling block G2 and made to be encrypted content Enc-Contents, and is transmitted to the drive 200.

The title key TK used for encrypting is transmitted to the drive 200 by using the bus authentication function H1. In this case, the title key TK is not transmitted as it is, and may be encrypted title key Enc-TK encrypted by a master key MK or disc key DK in the system of FIG. 13. Further, the bus authentication may be a protection system in which, even if the data is stolen at the transmitting line between the A/V encoder module 100 and the drive 200, the data cannot be utilized due to the session key CK being generated during the mutual authorizing processing and the title key TK or the encrypted title key Enc-TK being encrypted/decrypted by the session key CK. In the drive 200 to which encrypted content Enc-Contents and the encrypted title key Enc-TK are transmitted, error correction codes are added to the encrypted content Enc-Contents by the ECC H3, and the encrypted content Enc-Contents with the error correction codes is modulated by the modulator(a) H4, and thereafter, is recorded on the recording medium 300 by the writing section (Write Channel) H5.

The encrypted title key Enc-TK is modulated by the modulator(b) J2, and is recorded on the recording medium 300. Here, the modulator(b) J2 modulates the signal by using a conversion table such as that of FIG. 16. As this pattern, a pattern other than the pattern used in the main modulator(a) H4 is used.

At the reproducing side, a signal read from the recording medium 300 is reproduced by the modulator(a) H7, and the encrypted content Enc-Contents is restored by an error correction processing by the ECC block H8. On the other hand, the encrypted title key Enc-TK is demodulated by the demodulator(b) J2, and error-correction-processed by the key controlling circuit J4 or the like, and restored. Even when this data is demodulated by the main modulator(a) H7, it is not demodulated as the correct data. Even when unauthorized reading is carried out by an unauthenticated drive (a drive which is different from the drives 200 and 400 of the present embodiment), the correct encrypted signal cannot be restored.

The encrypted title key Enc-TK restored by the demodulator(b) J3 is transmitted to the A/V decoder module 500 after authentication processing of the bus authentication function H9 is carried out. In the A/V decoder module 500, the descrambling section E3 descrambles the transmitted encrypted content Enc-Contents by using the encrypted title key Enc-TK. The video/audio signal of the restored main data is finally restored by the A/V decoder E4.

If the system of FIG. 17 of the method of the present embodiment is used, illegal copying in an unauthorized route as described in FIG. 15 can be prevented. Further, even if a special concealed region is not provided in a recording region of the recording medium, concealed data which can be detected only in the drive can be utilized. Therefore, the copyright protection ability can be improved by a low-priced system. This ability is realized in a PC environment as well, and infrastructures such as conventional file systems or the like are possible without special agreements.

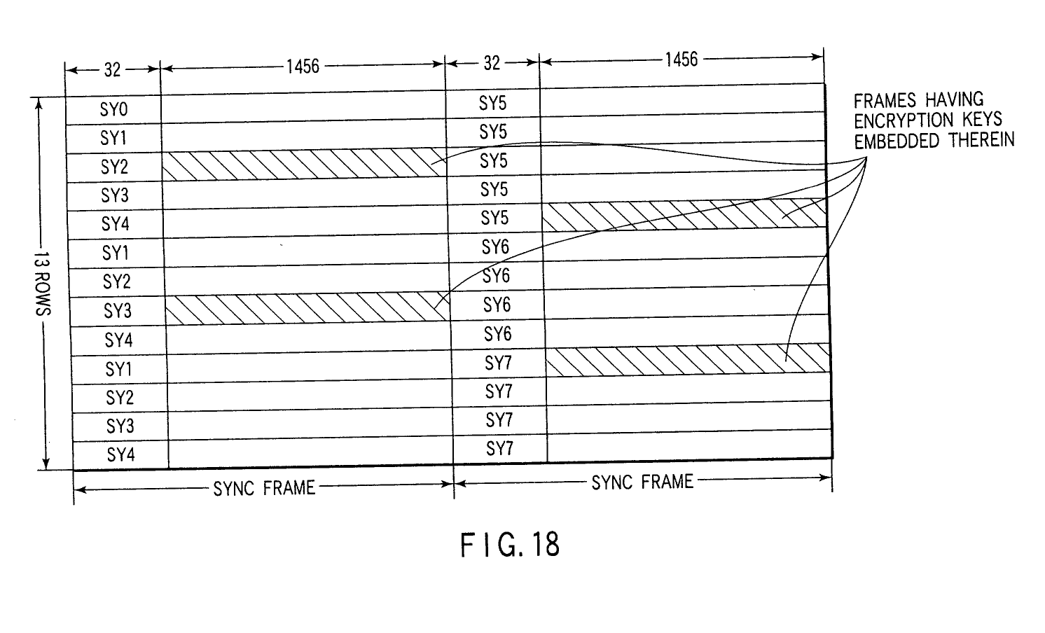

FIG. 18 shows the recording regions of the encrypted content Enc-Contents modulated by the modulator(a) H4 and the encrypted title key Enc-TK modulated by the modulator(b) J2. In the DVD system, as shown in FIG. 6, the ECC block (physical sector) after modulation is structured. Here, in the present embodiment, in a specific physical sector, a portion or the entire frame (the portion shown by hatchings) of a specific frame is replaced by the modulated signal of the encrypted title key Enc-TK generated by the modulator(b) J2. In this example, the frame to which synchronous codes SY2, SY5, SY3 and SY7 are added is replaced.

There is an error in the main data, there is no problem if the increase in errors is within a range of the correcting ability.

As the place where the modulated signal of the encrypted title key Enc-TK generated by the modulator(b) J2 is embedded, the initial position of the physical sector is designated. However, as the following positions, a position signal may be written together with the specific information at the previous place, such that the position cannot be viewed when viewed from the exterior.

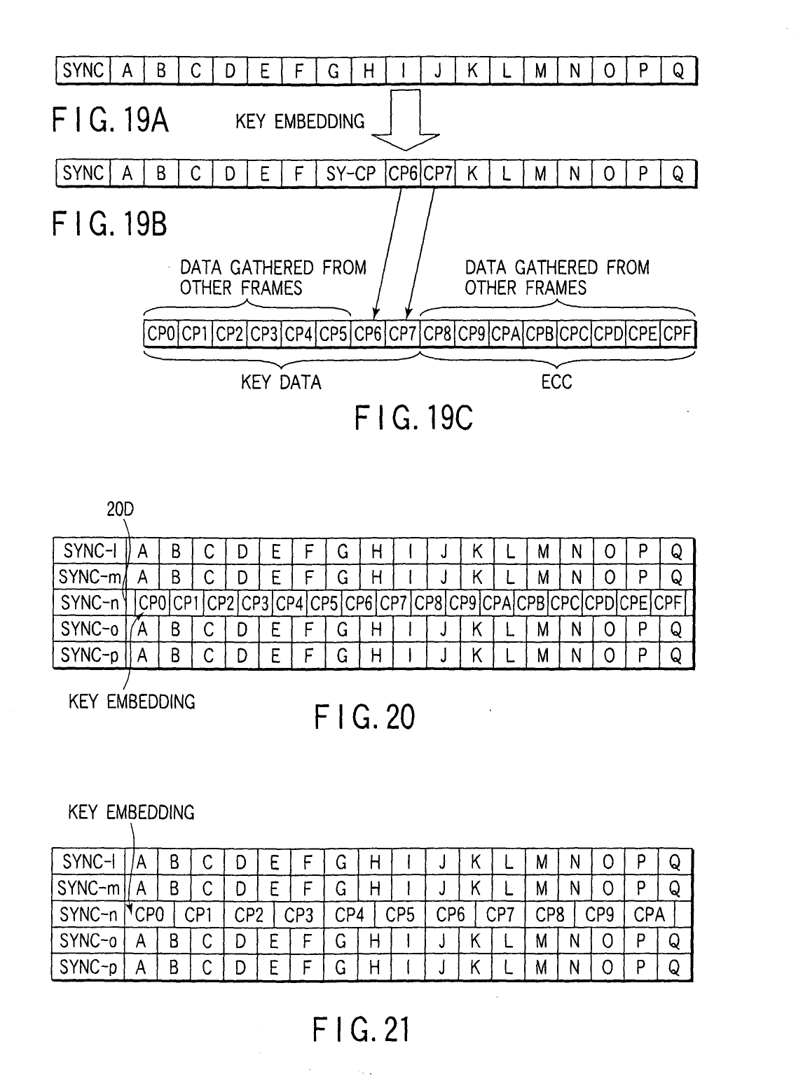

In FIGS. 19A, 19B, 19C, 20, and 21, specific examples of a method of embedding a modulated signal generated by the modulator(b) J2 are shown.

FIGS. 19A, 19B, and 19C are diagrams showing a first specific example of an encrypted key embedding technique. A particular pattern which is not used for main data modulation is embedded, as a synchronous signal SY-CP of the data of encrypted key embedding, into a portion of the specific frame (FIG. 19A) in FIG. 18. Next, an encrypted key of several data symbols is embedded (FIG. 19B). In this example, portions of CP6 and CP7 of the encrypted keys are embedded. If such a portion of the encrypted keys is taken out from other frames and gathered, as shown in FIG. 19C, the entire encrypted key can be acquired. An error correction code ECC is added to the encrypted key, and the reliability of the data is improved. Namely, the information of the encrypted key is the subject of error symbol correcting processing, and finally, the correct information of the encrypted key is restored.

In this case, the modulator(a) H4 may be used for the encrypted key information. The synchronous signal SY-CP having a particular pattern is in the main data region, and is error data. Therefore, even if it is processed at the route of demodulation→modulation in FIG. 15 (the route of demodulation(a)→modulation(a) in FIG. 17), the SY-CP pattern is not the same pattern as the previous pattern after modulation. Therefore, the synchronous code SY-CP completely disappear if a disc copy is performed. As a result, the synchronous code SY-CP disappears, and it is impossible to extract the encrypted key CP, and it is impossible to prepare an illegally copied disc.

FIG. 20 is a diagram showing a second specific example of an encrypted key embedding technique. In the physical sector shown in FIG. 18, the main data of 16 channel bits is arranged following the synchronous signal SYNC. Further, the encrypted key is arranged following the synchronous signal SYNC with inserting dummy bits 20D having constant channel bits, for example, 8 channel bits.

Namely, due to the dividing points of the symbols of the main data and the encrypted key being different, the encrypted key is not correctly demodulated by demodulation in only the main demodulator(a) H7.

When it is normally decrypted, it is demodulated by the demodulator(b) J3. Here, because the dummy portion is known in advance, it suffices that this portion is detected and the following data are demodulated.

FIG. 21 is a diagram showing a third specific example of an encrypted key embedding technique. In the code conversion table for modulation of a DVD shown in FIG. 16, a data symbol of 8 bits is converted to a data symbol of 16 bits. Here, when the bit distance from “1” to the next “1” of the channel bit is limited to 3 to 11 bits, it is almost impossible to structure another conversion table without using the pattern used in one conversion table.

Thus, when the data symbol (8 bits) is converted to channel bits for modulation, the modulator(b) J2 is formed of larger channel bits. In this case, the corresponding conversion tables for modulating and demodulating are provided at the modulating side and the demodulating side.

FIG. 21 is an example in which a data symbol of 8 bits is formed of, for example, 24 channel bits. In this way, by carrying out bit conversion, the encrypted key can be demodulated merely by a normal equipment.

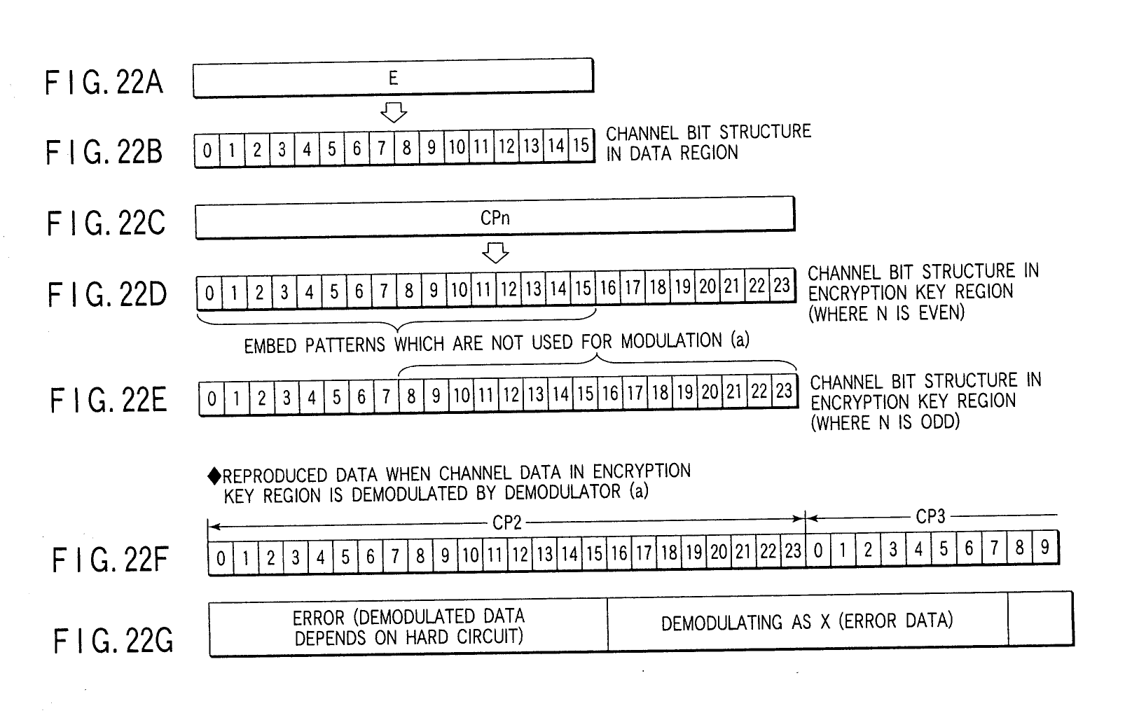

In FIG. 22A to FIG. 22G, the relationship of the conversion is illustrated. The main data converted in the main modulator(a) H4 is converted to 16 channel bits (FIGS. 22A and 22B). The data symbol of 8 bits of the encrypted key modulated by the modulator(b) J2 is converted to 24 channel bits (FIGS. 22C and 22D). 16 channel bits among the above-described 24 channel bits are embedded into the region of 16 channel bits at the first half side or the last half side of the 24 channel bits as a pattern which is not used in the main modulator(a) H4 (FIGS. 22D and 22E). When the modulated signal of the above-described encrypted key is extracted, the modulated signal is extracted from the region known in advance, and the encrypted key can be demodulated by using a particular conversion table.

Another embodiment may be realized as follows. Namely, in the symbol data CPn=CP0, CP1, CP3, . . . , when n is an even number and an odd number, the place for embedding the pattern which is not used in the main modulator(a) H4 may be set to the first half and the last half. An example, in which the pattern which is not used in the main modulator(a) H4 is embedded into the first half, is the example shown in FIG. 22D, and an example, in which the pattern which is not used in the main modulator(a) H4 is embedded into the last half, is the example shown in FIG. 22E.

In this case as well, when the modulated signal of the encrypted key is extracted, the modulated signal is extracted from the region known in advance, and the encrypted key can be demodulated by using a particular conversion table.

For example, in the main data modulator(a) H4 in the DVD standard, the distance from “1” to the next “1” is 3 to 11 bits, and the SYNC frame uses a 14 channel-bits pattern. Thus, the 12 channel bits into which the 24 channel bits are divided are arranged at the first half side or the last half side in the SYNC frame of the specific portion. In this way, due to the specific information being embedded into the physical sector, even if the pattern modulated by the modulator(b) J2 is demodulated by the main demodulator H7 and the data is again modulated into a recording pattern by the main modulator(a) H4, it is impossible to copy the correct encrypted key.

In the examples in FIG. 22A to FIG. 22G, a case in which a channel bit stream connected at the data symbols CP2 and CP3 of the encrypted key is demodulated by the main demodulator(a) H7 is shown. In the main demodulator(a) H7, the input data is divided at 16 channel bit units and demodulated, but the first 16 channel bits become data which does not return again to the original pattern (although the data depends on a demodulation circuit (hardware)).

The following 8 channel bits form 16 channel bits by connecting with the 8 channel bits of the head side of the data symbol CP3, and “data X” determined by this 16 channel bit pattern is demodulated (FIGS. 22F and 22G).

When these data are made pass through the error correction circuit, the encrypted key information disappears due to the correcting processing. However, when data for which the error correction processing is not carried out is transmitted to the exterior, due to copying processing being carried out through an illegal copying route such in FIG. 15, there is the strong possibility that this portion will again become the same as the pattern of the 8 channel bits at the last half side of the original data symbol CP2 and the 8 channel bits at the first half side of the data symbol CP3.

However, if illegal copying is to be carried out, by the data symbols CP2 and CP3, the 16 channel bit pattern at each of the first half side or the last half side thereof cannot be recorded as the same pattern. As a result, it is difficult to illegally copy the encrypted key.

By introducing this structure, even when there is a small number of patterns which are not used for the conversion table used for modulating the main data, it is possible to prevent illegal copying of the encrypted key.

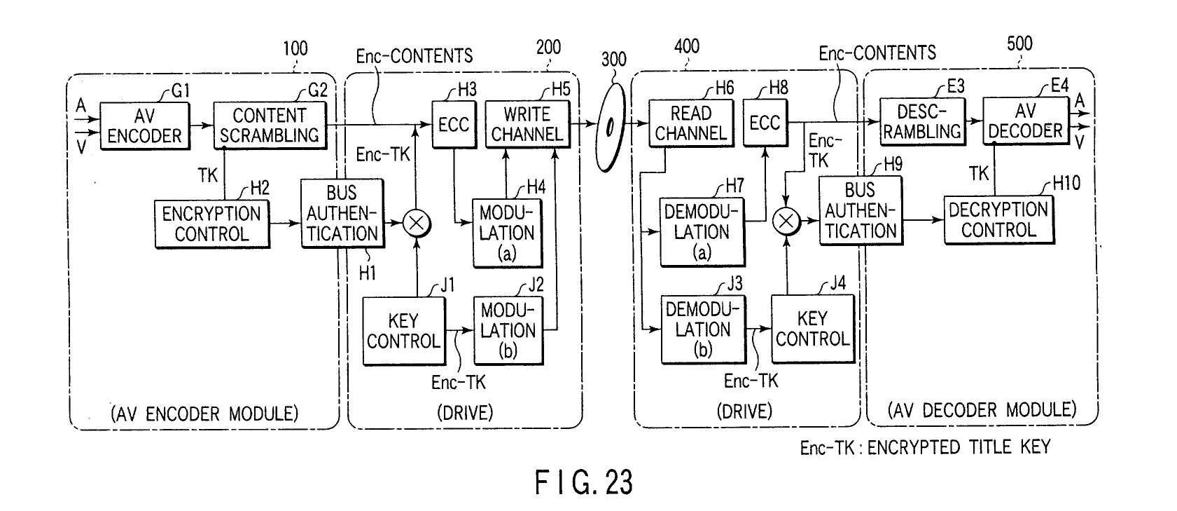

FIG. 23 is a modified example of the structural example shown in FIG. 17. The same reference numerals are given to the same portions as in the example of FIG. 17.

In the example of FIG. 17, the title key TK or the encrypted title key Enc-TK is modulated by the modulator(b) J2 and recorded on the recording medium 300. However, in the example of FIG. 23, the title key TK or the encrypted title key Enc-TK is encrypted by random data, and the random data used at this time is recorded by the main modulator(a) H4.

Namely, in this example, the title key TK used for encrypting the content is encrypted by random data generated by the drive 200 or specific control data from the exterior, and recorded by the main data recording section. The key controlling section J1 generates random data and supplies it to a multiplier L1. In the multiplier L1, the title key TK is encrypted, and the encrypted title key Enc-TK is supplied to the ECC encoding section H3. This encrypted title key Enc-TK is embedded into a specific position of the ECC block.

Or, in the same way as the data block containing the main data, the encrypted title key Enc-TK may be structured as an encrypted key information block including error correction codes of M rows×N columns.

The random data (specific information) is modulated by the modulator(b) J2, and supplied to the writing processing section H5. In the writing processing section H5, as described above, the modulated random data is embedded into blocks of a portion of the information block.

At the reproducing side, the signal reading section H6 supplies the read signal to the main demodulator(a) H7 and the demodulator(b) J3.

In the demodulator(b) J3, the modulated random data is extracted from frames of a portion of the ECC block and demodulated. The key controlling section J4 can thereby give random data for decrypting the encrypted title key Enc-TK to the multiplier L2. The encrypted title key Enc-TK can be obtained by the ECC decoder H8.

At the reproducing side, regular error correction by the ECC is carried out and reproduction is carried out. At this time, the random data used for re-encrypting the title key TK is recorded by the modulator(b) J2 under a concealed recording method. Thus, the random data and the encrypted title key Enc-TK can be demodulated and decrypted only within the drive 400. Therefore, even if only the encrypted content and the encrypted title key TK are read from the main data and copied, the copied content and the title key TK are not utilized them as they are.

As described above, the basic point of the present embodiment is that specific information is recorded and reproduced only by a drive by using a modulator other than the modulator for main data.

The concept of the present invention is not limited to the respective above-described embodiments, and combinations of the above-described respective embodiments are included in the concept. In accordance with the above-described embodiments, there are advantages which will be described hereinafter.

(1) By modulating the main data and the encrypted key by different modulators, it is difficult to acquire the encrypted key (specific information) in a general reproduction device. In particular, the concealing property improves due to the encrypted key being handled only in the drive.

(2) In a data block which is for recording or transmitting, the encrypted key does not ensure a specific placement site other than that of the main digital signal. By recording the encrypted key by replacing a portion of the main data region with data for the encrypted key as an error, it is difficult for an illegal to detect the encrypted key.

(3) When a modulated encrypted key is demodulated by the demodulator of the main digital signal, even if the demodulated data is modulated again by the modulator for the main digital signal, the original modulation pattern of the encrypted key cannot be restored. Namely, when the encrypted key is illegally demodulated and modulated, it becomes destroyed demodulated data. In accordance therewith, illegal copying of the encrypted key by an illegal user can be prevented.

(4) Because the recent RLL (Run Length Limited) modulating method improves the modulating efficiency, there are few patterns (unused patterns) remaining within the limits of the minimum/maximum inverting interval limited by the RLL. Thus, the minimum/maximum inverting interval limits of the second modulator are set to be different from the limits of the first modulator.

(5) When specific frames (a portion of the frames) of the data block are destroyed and the encrypted key (specific information) is arranged at this portion, a synchronous signal for an encrypted key and an encrypted key of several bytes are made a set. Therefore, the encrypted key is not arranged at a fixed position within the data block.

(6) Since the dividing point of the modulated signal of the information data and that of the modulated signal of the encrypted key (specific information) are not the same, data of the encrypted key are easily destroyed when the encrypted key is demodulated by the demodulator of a main information system.

(7) When specific frames (a portion of the frames) of the data block are destroyed and the encrypted key (specific information) is arranged at this portion, the modulation pattern used for the main data system is not used as the modulation pattern for the encrypted key. Thus, because many modulation patterns cannot be used, the usage efficiency of modulation patterns deteriorates. Namely, if an attempt is made to obtain the modulation pattern for the encrypted key at the same number of channel bits as that of the modulation pattern of the main data system, the pattern used for the encrypted key is greatly limited.

Thus, by increasing the number of channel bits in order to obtain the modulation pattern of the encrypted key, the modulated signal of the encrypted key can be easily destroyed by the demodulator of the main data system.

(8) The encrypted key is arranged in a main data region, and instead of it, the encrypted key is encrypted by specific information and arranged in the main data region. Further, due to the specific information being modulated by the second modulator and arranged at a concealed region, the concealed region can be made small.

(9) By modulating the main data and the encrypted key by different modulators, it is difficult to acquire the encrypted key (specific information) again at a general reproduction device, and a recording medium in which copyright protection is strengthened can be provided.

(10) A pattern which is not used as the modulation pattern of the first modulator is used as the modulation pattern or the synchronous signal of the encrypted key. However, when the modulated signal of the encrypted key is demodulated by a demodulator for a main digital signal, there is need to destroy the data. Thus, when a modulation pattern which is not used by the modulator of a main data system is input to the demodulator of main data, a demodulated data is set to fixed data, for example, all “0”s. Thus, there can be a system in which the modulation pattern of the encrypted key is not restored by the loop of main digital demodulation→main digital modulation.

More detailed description of the features of the above-described respective embodiments is as follows.

(A) Feature of Information Recording Medium

(A1) There is the feature as a recording medium, wherein a data block containing encrypted main data and error correction codes is formed of symbols of M rows×N columns (M×N), one row is divided into R frames, a synchronous signal is added to each frame, and data of each frame is modulated by a modulator, and an encrypted key for encrypting the main data is modulated by a modulator other than the modulator modulating the data of the above-described data block, and the above-described modulated frame and the modulated key are recorded.

(A2) There is the feature as a recording medium, wherein the encrypted key for encrypting the main data is modulated by a modulator other than the modulator modulating the data of the above-described data block, and is embedded into one or plural portions of the above-described modulated frame, and the concealed data block is recorded.

(A3) There is the feature as a recording medium, wherein the data of each frame is modulated by a modulator, and the encrypted key for encrypting the main data is replaced with a portion of the modulated signals of the above-described data block, and at this time, a pattern which is not generated by the above-described data block is replaced as a synchronous signal for an encrypted key, and continuously, the aforementioned modulated signal of the encrypted key is arranged, and the data block concealed in this way is recorded.

(A4) There is the feature as a recording medium, wherein 1 symbol of data of each frame is converted to S channel bits by a modulator, a portion of the frames of the above-described data block is replaced with the encrypted key encrypting the main data, and at this time, at a frame at which the encrypted key is arranged, a redundant dummy signal of T channel bits is added after the aforementioned synchronous signal, and thereafter, the modulated signal of the encrypted key is arranged in S channel bit units, and the data block concealed in this way is recorded.

(A5) There is the feature as a recording medium, wherein 1 symbol of data of each frame is converted to S channel bits, a portion of the frames of the above-described data block is replaced with the encrypted key encrypting the main data, and at this time, modulating processing in which 1 symbol is converted to U channel bits (where S and U are different integers) is applied to the modulation of the encrypted key, and the data block concealed in this way is recorded.

(A6) There is the feature as a recording medium, wherein each frame of the aforementioned data block is successively modulated by a first modulator, the encrypted key encrypting the aforementioned main data is encrypted by specific information and is structured as an encrypted key information block containing error correction codes of M rows×N columns in the same way as in the aforementioned data block and is modulated by the aforementioned first modulator, the specific information encrypting the encrypted key is modulated by a second modulator, a frame synchronous code is added to a modulated frame obtained from the aforementioned first modulator, and the modulated specific information obtained from the second modulator is arranged at a portion of the aforementioned first modulated frame, and the data block concealed in this way is recorded.

(B) Features of Signal Reproduction Method and Device

(B1) There is the feature as a signal reproduction method and device, wherein in order to respectively demodulate the modulated frame and the modulated key in the above-described item (A1), the aforementioned modulated frame is demodulated by the first demodulator, the aforementioned modulated key is demodulated by the second demodulator, and the demodulated frame is decrypted by using the demodulated key.

(B2) There is the feature as a signal reproduction method and device, wherein the concealed data block in the above-described item (A2) is received, the modulated key is extracted from a portion or portions of the above-described modulated frame and demodulated by a demodulator, the aforementioned modulated frame is demodulated by another demodulator, and the demodulated frame is error-corrected, and the modulated key contained therein disappears due to the error correction.

(B3) There is the feature as a signal reproduction method and device, wherein the concealed data block in the above-described item (A3) is received, a synchronous signal for the modulated key is detected from the above-described modulated frame, and the modulated signal of the encrypted key continuing after the synchronous signal for the modulated key is demodulated.

Further, there is the feature as a signal reproduction method and device, wherein a conversion table for demodulating the modulated signal of the aforementioned encrypted key and a conversion table for demodulating the modulated frame have different conversion patterns (codes).

(B4) There is the feature as a signal reproduction method and device, wherein the concealed data block in the above-described item (A4) is received, a redundant dummy signal of T channel bits following the synchronous signal of the above-described modulated frame is detected, and the modulated signal of the encrypted key of S channel bits units following thereafter is demodulated.

(B5) There is the feature as a signal reproduction method and device, wherein the concealed data block in the above-described item (A5) is received, and is demodulated to a number of channel bits U different from the number of channel bits S of the units demodulating the modulated signal of the aforementioned main data from the above-described modulated frame, and the aforementioned encrypted key is obtained from the demodulated output.

(B6) There is the feature as a signal reproduction method and device, wherein the concealed data block in the above-described item (A6) is received, and specific information is detected from the above-described modulated frame, and the aforementioned specific information is demodulated by a modulator different from the modulator demodulating the modulated signal of the above-described main data, and an encrypted key information block is extracted from the modulated frame, data of the encrypted key information block is decrypted by the demodulated specific information, and the aforementioned encrypted key is obtained.

The conversion pattern for demodulating the data of the data block of the above-described main data and the conversion pattern demodulating the aforementioned encrypted key are different.

Further, the conversion patterns for demodulating the encrypted key include inverting patterns exceeding the minimum inverting distance or the maximum inverting distance of the conversion pattern demodulating the modulated signal of the aforementioned main data.

As described above, even in a recording drive used in a computer environment and a system by a PC in which editing or the like of information is easy, a signal processing method, which has a copyright protection system which can prevent copying of a recording medium on which information for which copyright protection is required is recorded, and in which a plurality of contents are easily managed individually, can be provided.

What is claimed is:

1. A signal processing method comprising:
forming a data block including encrypted main data and an error correction code, the data block being formed of symbols of M rows×N columns, one row being divided into R frames (M, N, R being integers), and a synchronous signal being added to each frame of the data block;
modulating the encrypted main data by a first modulator;
modulating an encryption key of the main data by a second modulator; and
combining the modulated main data and the modulated encryption key to obtain an output to be recorded on a recording medium or transmitted on a transmission path.

2. The method according to claim 1, wherein the combining comprises embedding the modulated encryption key to a predetermined portion of the frame or all the frame of the modulated main data.

3. The method according to claim 2, wherein the embedding comprises replacing the predetermined portion of the frame of the modulated main data by a modulated pattern which is not output from the first modulator and the modulated encryption keys following the modulated pattern.

4. The method according to claim 2, wherein
the first modulator converts one symbol to S channel bits; and
the embedding comprising replacing all the frame of the modulated main data by a dummy bit of T channel bits following the synchronous signal and the modulated encryption keys of S channel bits (S and T being integers).

5. The method according to claim 2, wherein
the first modulator converts one symbol to S channel bits; and
the embedding comprises replacing all the frame of the modulated main data by the modulated encryption keys of U channel bits (S and U being integers).

6. A signal processing method comprising:
forming a data block including encrypted main data and an error correction code, the data block being formed of symbols of M rows×N columns, one row being divided into R frames (M, N, R being integers);
modulating each frame of the data block by a first modulator;
encrypting an encryption key of the main data by specific information;
forming a key block including encrypted encryption key and an error correction code, the key block being formed of symbols of M rows×N columns, the key block being supplied to the first modulator;
modulating the specific information by a second modulator; and
adding a synchronous signal to the modulated frame output from the first modulator and combining a predetermined modulated frame and the modulated specific information output from the second modulator to obtain an output to be recorded on a recording medium or transmitted on a transmission path.

7. The method according to claim 6, wherein a conversion pattern of the first modulator differs from a conversion pattern of the second modulator.

8. The method according to claim 7, wherein the conversion pattern of the second modulator comprises inverting patterns exceeding a minimum inverting distance or a maximum inverting distance of the conversion pattern of the first modulator.

9. A signal processing apparatus comprising:
a block forming unit which forms a data block including encrypted main data and an error correction code, the data block being formed of symbols of M rows×N columns, one row being divided into R frames (M, N, R being integers), and a synchronous signal being added to each frame of the data block;
a first modulator which modulates the encrypted main data;
a second modulator which modulates an encryption key of the main data; and
a combining unit which combines the modulated main data and the modulated encryption key to obtain an output to be recorded on a recording medium or transmitted on a transmission path.

10. The apparatus according to claim 9, wherein the combining unit comprises an embedding unit which embeds the modulated encryption key to a predetermined portion of the frame or all the frame of the modulated main data.

11. The apparatus according to claim 10, wherein the embedding unit comprises a replacing unit which replaces the predetermined portion of the frame of the modulated main data by a modulated pattern which is not output from the first modulator and the modulated encryption keys following the modulated pattern.

12. The apparatus according to claim 10, wherein
the first modulator converts one symbol to S channel bits; and
the embedding unit comprises a replacing unit which replaces all the frame of the modulated main data by a dummy bit of T channel bits following the synchronous signal and the modulated encryption keys of S channel bits (S and T being integers).

13. A signal processing apparatus comprising:
a data block forming unit which forms a data block including encrypted main data and an error correction code, the data block being formed of symbols of M rows×N columns, one row being divided into R frames (M, N, R being integers);
a first modulator which modulates each frame of the data block;
an encryption unit which encrypts an encryption key of the main data by specific information;
a key block forming unit which forms a key block including encrypted encryption key and an error correction code, the key block being formed of symbols of M rows×N columns, the key block being supplied to the first modulator;
a second modulator which modulates the specific information; and
a combining unit which adds a synchronous signal to the modulated frame output from the first modulator and combines a predetermined modulated frame and the modulated specific information output from the second modulator to obtain an output to be recorded on a recording medium or transmitted on a transmission path.

14. The apparatus according to claim 13, wherein a conversion pattern of the first modulator differs from a conversion pattern of the second modulator.

15. The apparatus according to claim 14, wherein the conversion pattern of the second modulator comprises inverting patterns exceeding a minimum inverting distance or a maximum inverting distance of the conversion pattern of the first modulator.

16. The apparatus according to claim 13, wherein the first modulator and second modulator are incorporated in a media drive.

17. A signal reproduction method comprising:
receiving the output obtained by the signal processing method according to claim 1;
demodulating the modulated main data by a first demodulator;
demodulating the modulated encryption key by a second demodulator; and
combining the demodulated main data and the demodulated encryption key to obtain the data block.

18. A signal reproduction apparatus comprising:
a receiving unit which receives the output obtained by the signal processing apparatus according to claim 9;
a first demodulator which demodulates the modulated main data;
a second demodulator which demodulates the modulated encryption key; and
a combining unit which combines the demodulated main data and the demodulated encryption key to obtain the data block.

19. The signal reproduction apparatus according to claim 18, wherein the first demodulator and second demodulator are incorporated in a media drive.

20. A recording medium storing the output obtained by the signal processing method according to claim 1.
